(19) United States
(12) Patent Application Publication
(10) Pub. No.: US 2007/0255669 A1
(43) Pub. Date: Nov. 1, 2007

(54) Method of marketing intangible and tangible products

(76) Inventor: Andriy Kashanov, Sarasota, FL (US)

Correspondence Address: JAMES RAY & ASSOCIATES, 2640 PITCAIRN ROAD, MONROEVILLE, PA, 15146, US

(21) Appl. No.: 11/789,940

(22) Filed: Apr. 26, 2007

Related U.S. Application Data
(60) Provisional application No. 60/795,129, filed on Apr. 26, 2006.

(51) Int. Cl. G06E 3/00

(52) U.S. Cl. 706/26; 705/77

(57) ABSTRACT

A method of marketing tangible and intangible products using existing devices and networks. Product information is transmitted along with content by radio stations. The information is displayed or is sent by text message to an integrated mobile telephone, radio, multimedia player. The user purchases the product by using a dedicated function to transmit the purchase information. The purchase is either accepted by the mobile telephone provider or approved by a financial institution and the order is fulfilled.

### CROSS REFERENCE TO RELATED APPLICATION

This patent application is related to and claims priority from U.S. Provisional Patent Application Ser. No. 60/795,129 filed Apr. 26, 2006.

### FIELD OF THE INVENTION

The present invention relates, in general, to a method of marketing of intangible and tangible products and, more particularly, this invention relates to use of existing communication devices such as mobile telephones, multimedia players, data storage devices, computers, servers, radio and television networks, cable and satellite television, wire and wireless networks and the internet. The use of Short Message Service (“SMS”), Radio Data System (“RDS”), Wireless Application Protocol (“WAP”) and Multimedia Message Service (“MMS”) to communicate between the existing devices to supply advertisements, product information, purchase information and confirmation of purchases.

### BACKGROUND OF THE INVENTION

Prior to the conception and development of the present invention, as is generally well known in the prior art, use of RDS to provide information for consumers to a radio receiver such as song title and performer. It is also well known that advertisements can be delivered by SMS to mobile telephones. A problem is providing a convenient method for the purchase of products or services upon receipt of the information. Methods have been proposed concerning coding of information. However, the use of a dedicated function to transmit the purchase order including the payment information without further encoding or messaging is not found in the prior art.

### SUMMARY OF THE INVENTION

The present invention provides a method for marketing and sales of products and services by using existing devices, networks and communications services.

Product information is transmitted to a primary receiver using an existing communication protocol. A mobile telephone with integrated multimedia player synchronizes with a primary receiver. The primary receiver and mobile telephone display product information. To purchase the product or service the consumer activates a dedicated “buy now” function that transmits encoded purchase information to a DDS. The DDS checks the availability of the product or service authorizes the purchase with a financial network or mobile telephone network. An order is transmitted for fulfillment or is fulfilled by the DDS, billed to the purchaser and a confirmation sent to the purchaser. Where the purchase is of downloadable music or video, the music or video is transmitted directly to the integrated mobile telephone, music player or video player as according to the purchase of music or video.

In another embodiment of the invention the product or service information is transmitted to a mobile telephone by SMS or other protocol and the consumer can initiate a purchase by using a dedicated “buy now” function on said mobile telephone to transmit the encoded purchase information as in the other embodiment.

### OBJECTS OF THE INVENTION

It is, therefore, one of the primary objects of the present invention to provide a convenient method of purchasing products and services.

Another object of the present invention is to provide a convenient method for initiation the purchase by use of a dedicated purchase function.

Still another object of the present invention is to provide a method to purchase music concurrently with its broadcast.

Yet another object of the present invention is to provide a convenient method to purchase products or service presented as text product information.

Yes another object of the present invention is provide sellers with a method to market products and services to mobile telephone users and enable said users to respond immediately to said marketing.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a diagram of the method

FIG. 2 is a diagram of the method drawn to another embodiment.

FIG. 3 is a plan view of mobile telephone

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

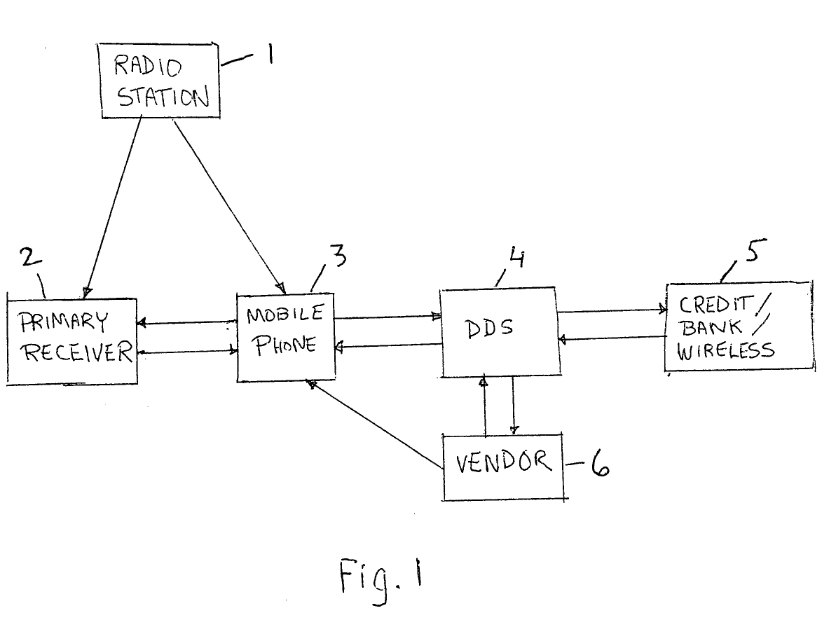

Reference is now made, more particularly, to FIG. 1. A terrestrial or satellite radio station (1) transmits content along with product or service information using a protocol such as RDS. The products or services by way of illustration include music, video, as well as other commercial services such as travel, video rental. These products or service are by way of illustration only and are not intended to limit the application.

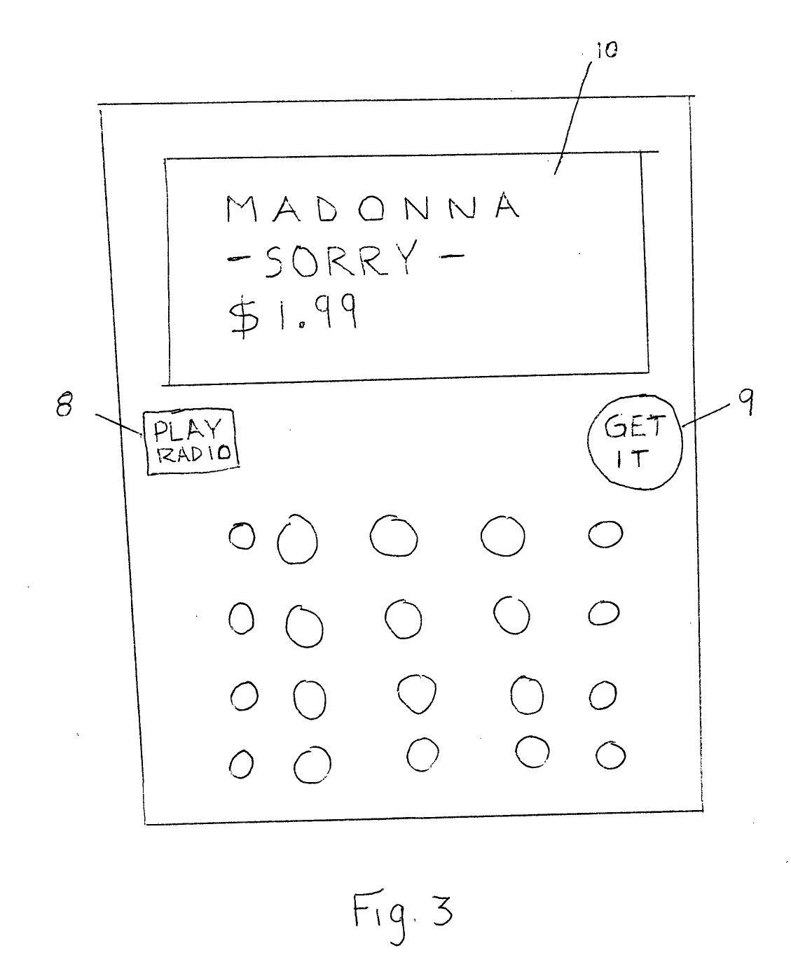

The primary receiver (2) such as a home or automobile radio displays the information. The mobile telephone (3) has an integrated multimedia player and radio. The user can synchronize tuning of the mobile telephone (3) with a primary receiver (2). The user activates a dedicate function of the mobile telephone (3) to play and synchronize the mobile telephone/radio (3) tuning with the primary receiver (2). FIG. 3 illustrates the dedicated function key to play the radio and synchronize tuning (8).

FIG. 3 illustrates the product or service information including price is displayed on the mobile telephone (10). The user initiates the purchase with a dedicated function key (9). The “Get It” dedicate function key (9) causes the mobile telephone to transmit encoded purchase information including the product and account information to the DDS (4) by a protocol such as SMS.

The DDS (4) sends a request for authentication and billing for said account with the bank, credit provider or wireless network provider (5). Upon receiving authentication, the DDS sends a confirmation to the mobile telephone using a protocol such as SMS. If the product or service is downloadable, the DDS (4) transmits it directly to the mobile telephone. If the order fulfillment is by a third party vendor (6) a message is sent to the vendor.

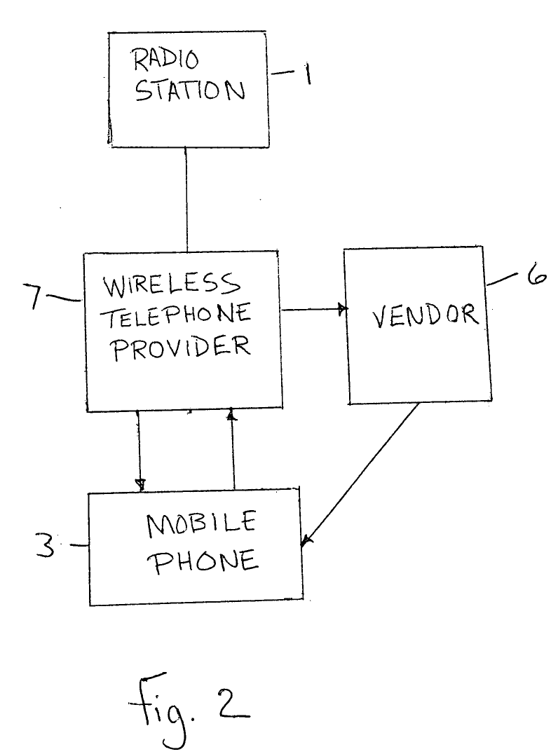

In a another embodiment, turning to FIG. 2, the product and price information is broadcast by a radio station (1) and is transmitted by the mobile telephone provider (7) by encoded message such as SMS to the user.

For example, the user message inbox would be in the following format:

### APR22 11:03 AM MADONNA O6 “TIME GOES BY SO SLOWLY”—$0.99

### APR22 11:05 AM FERGIE O7 “GLAMOROUS”—$1.49

### APR22 11:06 AM EXPEDIA® BAHAMAS 4NIGHTS FLY&HOTL—$699

### APR22 11:08 AM BLOCKBUSTER® CASINO ROYALE 07—$4.99

### APR22 11:10 AM N FURTADO 07 “SAY IT RIGHT”—$1.49

The user replies to the SMS. The mobile telephone (3) has purchase information such as the account information encoded. There for no further information is required to be entered.

The mobile telephone provider (7) does not require credit authorization outside of its network as it can bill the user directly on its invoice for the mobile telephone.

Where the product is downloadable, the wireless mobile telephone provider (7) downloads by transmitting directly to the integrated mobile telephone and multimedia player. The mobile telephone provider (7) can use a protocol such as MMS.

Where the product is not downloadable a message is transmitted by the mobile telephone provider (7) to the vendor (6) for order fulfillment.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. A method comprising:
(a) a radio station or network transmits content along with encoded product and price information;
(b) synchronizing of a mobile telephone with integrated multimedia player and radio to the tuning a primary radio receiver that is enabled to receive coded product information;
(c) receiving by the primary receiver of encoded information as to the identity and price of the product or service offered by sale by the primary receiver;
(d) displaying the product or service information by the primary receiver;
(e) deciding to purchase product or service;
(f) engaging a dedicated mobile telephone key for the purchase of the product or service;
(g) transmitting encoded purchase information and account information from the mobile telephone to a DDS;
(h) receiving encoded purchase information and account information by said DDS;
(i) authorizing by DDS of purchase of product or service from credit institution;
(j) transmitting to mobile telephone of by DDS confirmation of purchase
(k) fulfilling purchase order.

2. A method of claim 1 where the said primary receiver is RDS enabled.

3. A method of claim 1 where said RDS enabled receiver displays said product or service information.

4. A method of claim 1 where said encoded purchase information is transmitted by SMS from said mobile telephone to said DDS.

5. A method of claim 1 where said transmitting by DDS to said mobile telephone of said confirmation of purchase is by SMS.

6. A method of claim 1 where said primary receiver is a car radio.

7. A method of claim 1 where said credit institution is among a group of credit card network, bank and mobile telephone provider.

8. A method of claim 1 including an additional step of checking product or service availability by DDS.

9. A method of claim where the step of fulfilling the order where said order is the purchase of a song or video is to transmit said song or video to said mobile telephone by MMS.

10. A method of claim 1 where the step of fulfilling the order is to transmit said order to a third party for fulfillment.

11. A method comprising:
(a) offering products or service for sale by radio station
(b) receiving a message with product or service information, including product or service identification and price, from a wireless telephone provider to a mobile telephone that has stored account information, with integrated multimedia player, including identifying the product or service and the price;
(c) displaying said product or service information by the mobile telephone
(d) deciding to purchase product or service;
(e) replying to said message by a using dedicated function to transmit product or service information and said account information to mobile telephone provider;
(f) receiving encoded purchase information and said account information;
(g) transmitting to mobile telephone by mobile telephone provider of confirmation of purchase
(i) fulfilling purchase order.

12. A method of claim 11 where said message received by said mobile telephone is an SMS message.

13. A method of claim 11 where said encoded purchase information is transmitted by SMS from said mobile telephone to said mobile telephone provider.

14. A method of claim 11 where said transmitting by mobile telephone provider to said mobile telephone of said confirmation of purchase is by SMS.

15. A method of claim 11 including an additional step of checking product or service availability by mobile telephone provider.

16. A method of claim where the step of fulfilling the order where said order is the purchase of a song is to transmit the song to said mobile telephone.

17. A method of claim 11 where the step of fulfilling the order is to transmit the order to a third party for fulfillment.
